(19) United States
(12) Patent Application Publication
(10) Pub. No.: US 2026/0227275 A1
(43) Pub. Date: Aug. 6, 2026

(54) OPTICAL MEASUREMENT SYSTEM

(71) Applicant: OPTICS11 B.V., Amsterdam (NL)

(72) Inventors: Stefan WERZINGER, Amsterdam (NL); Nicola PIVA, Amsterdam (NL); Aydin ZADEH, Amsterdam (NL); Grzegorz GRUCA, Amsterdam (NL); Niek RIJNVELD, Amsterdam (NL)

(21) Appl. No.: 19/153,249

(22) PCT Filed: Feb. 7, 2024
(86) PCT No.: PCT/NL2024/050062

§ 371 Date: Aug. 1, 2025

(30) Foreign Application Priority Data
Feb. 7, 2023 (NL) 2034108

(51) Int. Cl. G01M 7/02; G01H 9/00

(52) U.S. Cl. CPC G01M 7/025; G01H 9/004

(57) ABSTRACT

In an optical measurement system, an optical sensor assembly receives stimulus light and provides response light conveying information on a physical quantity to be measured. An optical interrogator provides the stimulus light and extracts the information on the physical quantity from the response light. The optical sensor assembly includes a pair of reflective optical arms. The return response of one reflective optical arm and of the other reflective optical arm vary with the physical quantity to be measured. An optical coupler provides the response light as an interferometric combination of the return light from the one reflective optical arm and the return light from the other reflective optical arm. The optical coupler is located at a distance from the optical interrogator that is at least an order of magnitude larger than a distance range from the optical coupler within which the pair of reflective optical arms are deployed.

### CROSS-REFERENCE TO RELATED APPLICATION(S)

This is a National Stage Entry into the United States Patent and Trademark Office from International Patent Application No. PCT/NL2024/050062, filed on Feb. 7, 2024, which relies on and claims priority to Netherlands Patent Application No. 2034108, filed on Feb. 7, 2023, the entire contents of both of which are incorporated herein by reference.

### FIELD OF THE INVENTION

An aspect of the invention relates to an optical measurement system that is capable of measuring a physical quantity. The optical measurement system may be used, for example, to carry out nondestructive testing of a mechanical structure, or to monitor a mechanical structure that may be subject to wear, or both. The latter is generally referred to as structural health monitoring. Another aspect of the invention relates to use of an optical measurement system for measuring a physical quantity.

### BACKGROUND OF THE INVENTION

An optical sensor may be used to measure a physical quantity. In general, the optical sensor comprises an optical path having an optical characteristic that varies with the physical quantity to be measured. Light that has traversed the optical path is affected by the optical characteristic and thus carries information on the physical quantity to be measured. Optical interferometry may be used to retrieve this information. In that case, the light that has traversed the optical path is made to interfere with light that has traversed a different optical path, or light that has traversed the optical path differently. This produces interference light that also carries the information on the physical quantity but in a form that is more easily detectable.

An optical measurement system generally comprises a so-called optical interrogator in addition to an optical sensor, which may be part of a set of optical sensors in the system. The optical interrogator basically carries out two functions. Firstly, the optical interrogator provides the light that traverses the optical path of the optical sensor. Secondly, the optical interrogator retrieves the information on the physical quantity to be measured. This information is carried by the light that has traversed the optical path of the optical sensor, or is provided by the aforementioned interference light in case optical interferometry is used.

An optical sensor is particularly suited for measuring a physical quantity in an environment that is harsh or hazardous, or both. The optical path of the optical sensor, which may comprise, for example, an optical fiber, can be resistant against harshness of the environment. The harshness may be due to, for example, an extreme temperature, a high-pressure, a chemically aggressive substance, a strong electric or electromagnetic field, or strong radiation, or any combination of these. What is more, the light that traverses the optical path is not susceptible of causing fire and explosion, the risk of which may make the environment hazardous.

A physical quantity that is measured may concern, for example, an acoustic emission by a mechanical structure that is subject to a force. This is generally referred to as acoustic emission testing. Acoustic emissions provide information on the mechanical structure, in particular its integrity and its state of wear. What is more, a defect within the mechanical structure may be located and characterized. Namely, a defect, such as, for example, a crack, a delamination, corrosion, and a debonding, releases energy in the form of relatively high-frequency sound waves. These sound waves, which travel along elements of the mechanical structure, convey information about the defect concerned.

Acoustic emission testing may thus be used in, for example, nondestructive testing and structural health monitoring mentioned hereinbefore. In these applications, piezoelectric transducers are generally used to detect and measure acoustic emissions. However, piezoelectric transducers may not be suitable, or even unusable, in an environment that is harsh or hazardous, or both. An optical sensor could withstand such an environment. However, to date, there have been few commercially successful optical measurement systems for acoustic emission testing.

Patent publication WO2019170194 describes a measuring device for determining a physical measurement variable. The device comprises an optical coupler having at least 3 coupler inputs and a same number of coupler outputs. A first light wave signal is applied at a first coupler input. A second light wave signal is applied at a second coupler input. The first and the second light wave signal can be subject to interference and have a measurement-variable-dependent phase shift that corresponds to a physical measurement variable. A first optical interference signal is present at a first coupler output, which represents a first interference of the first and the second light wave signal. A second optical interference signal is present at a second coupler output, which represents a second interference of the first and the second light wave signal. The second optical interference signal has a coupler-dependent phase shift that is not equal to m·π (where m∈Z) in relation to the first optical interference signal. A first optical detector receives the first optical interference signal at a first detector input and provides a first electrical output signal at a first detector output. A second optical detector receives the second optical interference signal at a second detector input and provides a second electrical output signal. An evaluation unit determines the physical measurement variable from the first and the second electrical output signal.

### SUMMARY OF THE INVENTION

There is a need for an optical measurement technique that allows sensitive and precise measurement of a physical quantity by means of an optical interrogator that is at a relatively large distance from where the physical quantity is to be measured.

An aspect of the invention provides for an optical measurement system comprising:
an optical sensor assembly adapted to receive stimulus light and to provide, in response, response light conveying information on a physical quantity to be measured; and
an optical interrogator adapted to provide the stimulus light and to extract the information on the physical quantity from the response light;
   wherein the optical sensor assembly comprises:
a pair of reflective optical arms each adapted to receive input light at a coupling end and to provide, in response, return light at the coupling end according to a return response, wherein the return response of one reflective optical arm of the pair and the return response of the other reflective optical arm of the pair vary differently with the physical quantity to be measured;
an optical coupler that is optically coupled with the optical interrogator, the optical coupler being adapted to apply a portion of the stimulus light to the coupling end of the one reflective optical arm of the pair, and another portion of the stimulus light to the coupling end of the other reflective optical arm of the pair, and to provide the response light as at least one interferometric combination of the return light from the one reflective optical arm of the pair and the return light from the other reflective optical arm of the pair,
   wherein the optical coupler is located at a distance from the optical interrogator that is at least an order of magnitude larger than a distance range from the optical coupler within which the pair of reflective optical arms are deployed.

A further aspect of the invention concerns use of an optical measurement system as defined hereinbefore for measuring a physical quantity.

In each of these aspects, Rayleigh scattering is prevented from significantly impairing measurement sensitivity and measurement precision. Measurement sensitivity and measurement precision are particularly impaired by Rayleigh scattering in the reflective optical arms of the sensor assembly. Rayleigh scattering in these reflective optical arms adds noise, disturbances, to the information on the physical quantity provided by the interferometric combination. Rayleigh scattering may also weaken this information. The longer the reflective optical arms of the sensor assembly are, the greater the extent to which Raleigh scattering adds noise to and weakens the aforementioned information of interest.

The optical measurement technique in accordance with the invention allows the aforementioned reflective optical arms to be relatively short because the optical coupler may be relatively close to where the physical quantity is measured. Accordingly, the extent to which Raleigh scattering adds noise to and weakens the information on the physical quantity is relatively low. This is particularly true compared with a measurement technique in which the optical coupler is present within the optical interrogator, or relatively close to the optical interrogator. The optical measurement technique in accordance with the invention thus allows sensitive and precise measurement of a physical quantity, in particular if the optical interrogator is at a relatively large distance from where the physical quantity is to be measured.

For the purpose of illustration, some embodiments of the invention are described in detail with reference to accompanying drawings. In this description, additional features will be presented, some of which are defined in the dependent claims, and advantages will be apparent.

### BRIEF DESCRIPTION OF THE DRAWINGS

FIG. 1 is a schematic block diagram of a first exemplary optical measurement system.

FIG. 2 is a schematic block diagram of a second exemplary optical measurement system.

FIG. 3 is a schematic block diagram of a third exemplary optical measurement system.

FIG. 4 is a schematic block diagram of a fourth exemplary optical measurement system.

FIG. 5 is a schematic block diagram of a fifth exemplary optical measurement system.

FIG. 6 is a schematic block diagram of a sixth exemplary optical measurement system.

### DESCRIPTION OF EMBODIMENT(S) OF THE INVENTION

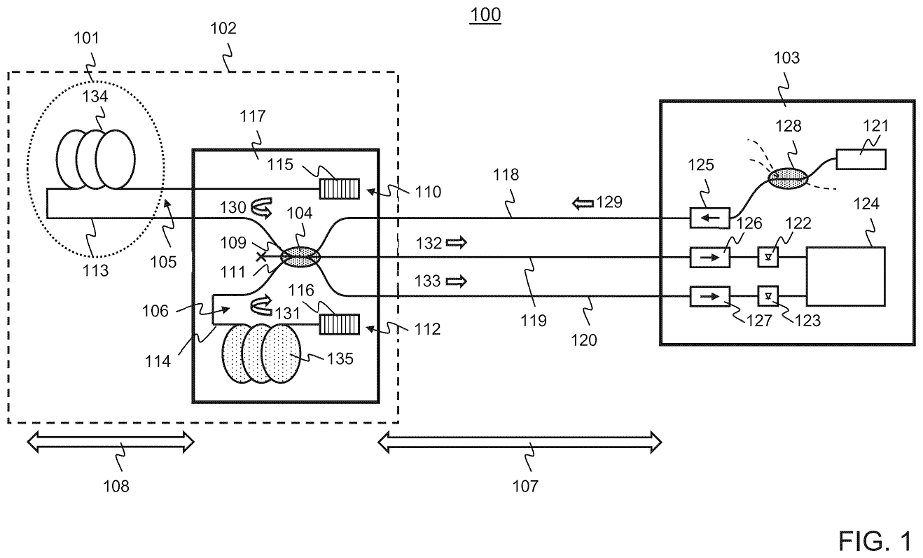

FIGS. 1-6 schematically illustrate various exemplary optical measurement systems 100-600. FIGS. 1-6 each provide a schematic block diagram of an exemplary optical measurement system. Each of the exemplary optical measurement systems 100-600, as well as variants thereof, may be used for measuring a physical quantity in an environment 101 that is harsh or hazardous, or both. The physical quantity to be measured may concern, for example, an acoustic emission by a mechanical structure that is subject to a force. Each of the exemplary optical measurement systems 100-600 may thus be used, for example, to carry out nondestructive testing of a mechanical structure, or to monitor a mechanical structure that may be subject to wear, or both. The latter is generally referred to as structural health monitoring.

The exemplary optical measurement systems 100-600 have certain features in common, which will be discussed first. The exemplary optical measurement systems 100-600 each comprise an optical sensor assembly 102 and an optical interrogator 103. The optical sensor assembly 102 comprises an optical coupler 104 and a pair of reflective optical arms 105, 106. On the one hand, the optical coupler 104 is optically coupled to the optical interrogator 103. On the other hand, the optical coupler 104 is coupled to the pair of reflective optical arms 105, 106.

The optical coupler 104 is located at a distance 107 from the optical interrogator 103 that is at least an order of magnitude larger than a distance range 108 from the optical coupler 104 within which the pair of reflective optical arms are deployed. For example, let it be assumed that the distance range 108 within which the pair of reflective optical arms are deployed is less than 10 m. In that case, the distance 107 at which the optical coupler 104 is located from the optical interrogator 103 may be at least 100 m. This particular feature, as well as advantages thereof, will be discussed in greater detail hereinafter.

In the exemplary optical measurement systems 100-600, one reflective optical arm 105 of the pair traverses, at least partially, the environment 101 where the physical quantity is to be measured. This reflective optical arm 105 will be referred to hereinafter as the sensing arm 105. The other reflective optical arm 106 of the pair does not traverse this environment 101 or, at least, not significantly. This reflective optical arm 106 will be referred to hereinafter as the reference arm 106 for the sake of convenience.

Specifically, the sensing arm 105 has two ends 109, 110. One end 109 is coupled with the optical coupler 104 and will therefore be referred to hereinafter as the coupling end 109. In this embodiment, the other end 110 is optically reflective and will therefore be referred to hereinafter as the reflective end 110. Similarly, the reference arm 106 has two ends 111, 112, one of which 111 is coupled with the optical coupler 104. This end will therefore also be referred to hereinafter as the coupling end 111. The other end 112 is optically reflective and will therefore also be referred to hereinafter as the reflective end 112.

The sensing arm 105 and the reference arm 106 each have an optical path length, which extends from the coupling end 109, 111 to the reflective end 110, 112, respectively. The optical path length of the sensing arm 105 may match that of the reference arm 106 in case these arms 105, 106 are subject to identical environmental conditions. That is, the optical path lengths may nominally correspond to each other.

In the exemplary optical measurement systems 100-600, the sensing arm 105 and the reference arm 106 may each comprise an optical fiber 113, 114. The optical fiber 113 of the sensing arm 105 will be referred to hereinafter as the sensing fiber 113. The optical fiber 114 of the reference arm 106 which will be referred to hereinafter as the reference fiber 114. Further, in the exemplary optical measurement systems 100-600, the reflective end 110 of the sensing arm 105 may comprise a Faraday rotating mirror 115, which is optically coupled to the sensing fiber 113. Similarly, the reflective end 112 of the reference arm 106 comprise a Faraday rotating mirror 116, which is optically coupled to the reference fiber 114.

In the exemplary optical measurement systems 100-600, the optical path length of the sensing arm 105 depends on a length that the sensing fiber 113 has, as well as on optical characteristics that the sensing fiber 113 has, in particular an effective refractive index. Similarly, the optical path length of the reference arm 106 depends on a length that the reference fiber 114 has, as well as on optical characteristics that the reference fiber 114 has, in particular an effective refractive index. The sensing fiber 113 and the reference fiber 114 may have similar optical characteristics. For example, the sensing fiber 113 and the reference fiber 114 may each be a section cut from a same bulk optical fiber. The optical path length of the sensing arm 105 then matches that of the reference arm 106 if the length of the sensing fiber 113 matches that of the reference fiber 114.

The exemplary optical measurement systems 100-600 each comprise a coupling unit 117 that houses the optical coupler 104. The coupling unit 117 further houses the reflective end 110 of the sensing arm 105 and the reflective end 112 of the reference arm 106. This implies that the coupling unit 117 may house the Faraday rotating mirror 115 that is coupled to the sensing fiber 113, as well as the Faraday rotating mirror 116 that is coupled to the reference fiber 114.

In the exemplary optical measurement systems 100-600, a group of optical fibers 118-120 optically couple the optical coupler 104 with the optical interrogator 103. The group of optical fibers 118-120 comprises an optical fiber 118 that will be referred to as the forward fiber 118 for a reason that will become apparent hereinafter. The group of optical fibers comprises two further optical fibers 119, 120 that will be referred to as the first return fiber 119 and the second return fiber 120, respectively, for a reason that will become apparent hereinafter too.

In the exemplary optical measurement systems 100-600, the optical coupler 104 may be, for example, of the N×N type, N being an integer having a value of at least 3. The optical coupler 104 may thus have two sets of optical ports, each set comprising N optical ports. One of these two sets comprises optical ports that are coupled with the group of optical fibers 118-120 that optically couple the optical coupler 104 with the optical interrogator 103. These optical ports will be referred to as front side ports for the sake of convenience. The other one of the two sets comprises optical ports that are coupled with the pair of reflective optical arms 105, 106. These optical ports will be referred to hereinafter as back side ports for the sake of convenience. In the exemplary optical measurement systems 100-600 illustrated in FIGS. 1-6, the optical coupler 104 is a 3×3 coupler by way of example.

Specifically, a first front side port of the optical coupler 104 may be coupled with the forward fiber 118, a second front side port may be coupled with the first return fiber 119, and a third front side port may be coupled with the second return fiber 120. A first back side port of the optical coupler 104 may be coupled with an end of the sensing fiber 113 that constitutes the coupling end 109 of the sensing arm 105. A second back side port may be coupled with an end of the reference fiber 114 that constitutes the coupling end 111 of the reference arm 106. A further back side port may be coupled with a non-reflective optical termination.

In the exemplary optical measurement systems 100-600, the optical interrogator 103 comprises a light source 121, a set of optical detectors 122, 123, and a measurement processor 124. The light source 121 may be in the form of, for example, a laser, more specifically, a coherent laser with a narrow linewidth, which may be, for example, less than 10 kHz. The set of optical detectors 122, 123 may comprise a first optical detector 122 and a second optical detector 123, each of which may comprise a photo diode or another type of optoelectrical transducer. The measurement processor 124 may comprise one or more electrical circuits, which may include an analog-to-digital converter, and a data processing circuit, which may execute instructions stored in a program memory.

An optical forward path extends from the light source 121 in the optical interrogator 103 to the optical coupler 104 in the optical sensor assembly 102. The optical forward path comprises an optical isolator 125 in addition to the forward fiber 118. This optical isolator will be referred to hereinafter as forward isolator 125 for the sake of convenience. Conversely, an optical return path extends from the optical coupler 104 in the optical sensor assembly 102 to the set of optical detectors 122, 123 in the optical interrogator 103. In the exemplary embodiments, the optical return path comprises two branches. A first branch of the optical return path comprises a first optical isolator 126 in addition to the first return fiber 119. A second branch of the optical return path comprises a second optical isolator 127 in addition to the second return fiber 120. The aforementioned first optical isolator 126 and second optical isolator 127 will be referred to a hereinafter as first return isolator 126 and second return isolator 127, respectively, for the sake of convenience.

The optical interrogator 103 may comprise an optical splitter 128 of which an input is coupled to the light source 121 as illustrated in FIGS. 1-6. An output of the optical splitter 128 is coupled to the optical sensor assembly 102 through the forward fiber 118. One or more further outputs of the optical splitter 128 may be coupled to one or more further optical sensor assemblies, which may be similar to any embodiment of the optical sensor assembly 102 illustrated in FIGS. 1-6. Indeed, the optical interrogator 103 may be configured to interrogate multiple optical sensor assemblies in a manner similar to that in which the optical sensor assembly 102 in FIGS. 1-6 is interrogated, which will be described hereinafter.

The exemplary optical measurement systems 100-600 illustrated in FIGS. 1-6 basically operate as follows. The light source 121 in the optical interrogator 103 generates light of which at least a portion constitutes stimulus light 129 that reaches the optical coupler 104 in the optical sensor assembly 102. In the exemplary optical measurement systems 100-600, the stimulus light 129 reaches the optical coupler 104 through the optical forward path, which includes the forward fiber 118 and the forward isolator 125. The optical coupler 104 receives the stimulus light 129 at its first front side port. The forward isolator 125 prevents unwanted reflections between the optical coupler 104 in the optical sensor assembly 102 and the light source 121 in the optical interrogator 103.

The optical coupler 104 splits the stimulus light 129 received from the optical interrogator 103 into several portions. One portion of the stimulus light 129 leaves the optical coupler 104 at the first back side port. Accordingly, the optical coupler 104 applies this portion to the coupling end 109 of the sensing arm 105. This portion of the stimulus light 129 will be referred to hereinafter as sensing input light for the sake of convenience. Another portion of the stimulus light 129 leaves the optical coupler 104 at the second back side port. Accordingly, the optical coupler 104 applies this portion to the coupling end 111 of the reference arm 106. This portion of the stimulus light 129 will be referred to hereinafter as reference input light for the sake of convenience.

In response to the sensing input light, the sensing arm 105 provides return light 130 at its coupling end 109 according to a return response. This return light 130 and return response will be referred to hereinafter as sensing return light 130 and sensing response, respectively, for the sake of convenience. The sensing response depends on the optical path length of the sensing arm 105. In turn, the optical path length of the sensing arm 105 depends on the length of the sensing fiber 113. This length may vary with the physical quantity to be measured.

Similarly, in response to the reference input light, the reference arm 106 provides return light 131 at its coupling end 111 according to a return response. This return light 131 and return response will be referred to hereinafter as reference return light 131 and reference response, respectively, for the sake of convenience. The reference response depends on the optical path length of the reference arm 106. In turn, the optical path length of the reference arm 106 depends on the length of the reference fiber 114. This length does not vary with the physical quantity to be measured or, at least, varies with the physical quantity to a significantly lesser extent than to which the length of the sensing fiber 113 varies with the physical quantity.

The optical coupler 104 receives the sensing return light 130 from the sensing arm 105 at its first back side port. The optical coupler 104 further receives the reference return light 131 from the reference arm 106 at its second back side port. The optical coupler 104 interferometrically combines the sensing return light 130 and the reference return light 131. In this embodiment, the optical coupler 104 makes two different interferometric combinations of the sensing return light 130 and the reference return light 131. The optical coupler 104 provides a first interferometric combination 132 at its second front side port. The optical coupler 104 further provides a second interferometric combination 133 at its third front side port.

The two different interferometric combinations 132, 133 each have an intensity that depends on a phase difference between the sensing return light 130 and the reference return light 131. In turn, the phase difference depends on a difference between the optical path length of the sensing arm 105 and that of the reference arm 106. This difference in optical path length may be directly related to a difference between the length of the sensing fiber 113 and that of the reference fiber 114. In turn, the aforementioned difference in length depends on the physical quantity to be measured.

The two different interferometric combinations 132, 133 differ from each other in that predefined different phase offsets are applied to the phase difference between the sensing return light 130 and the reference return light 131 when these are interferometrically combined. This allows determining sign and magnitude of the phase difference between the sensing return light 130 and the reference return light 131 on the basis of the first interferometric combination 132 and the second interferometric combination 133. In the exemplary optical measurement systems 100-600 illustrated in FIGS. 1-6, the optical coupler 104 is a 3×3 coupler, providing a relative phase offset of 120°.

In practice, the stimulus light 129 will have phase noise, which may potentially affect measurement precision. The phase noise of the stimulus light 129 will be transferred to the sensing return light 130 and the reference return light 131. A phase noise cancellation effect may be obtained when making an interferometric combination between the sensing return light 130 and the reference return light 131. The phase noise cancellation effect is maximal if the optical path length of the sensing arm 105 and that of the reference arm 106 nominally correspond to each other, as mentioned hereinbefore. In that case, the interferometric combination will have minimal phase noise. This applies to the first interferometric combination 132 and the second interferometric combination 133 made in the optical coupler 104 described hereinbefore.

In response to the stimulus light 129, the optical sensor assembly 102 thus provides response light that comprises two components. One of these two components is the first interferometric combination 132 formed in the optical coupler 104. The other component of the response light is the second interferometric combination 133 formed in the optical coupler 104. The response light conveys information on a physical quantity to be measured as can be understood from the preceding discussion on the two different interferometric combinations 132, 133 that constitute the two components of the response light.

The optical interrogator 103 receives the response light through the optical return path. Specifically, the first optical detector 122 in the optical interrogator 103 receives the first interferometric combination 132 through the first return fiber 119 and the first return isolator 126. The second optical detector 123 receives the second interferometric combination 133 through the second return fiber 120 and the second return isolator 127. The first return isolator 126 prevents unwanted reflections between the optical sensor assembly 102 and the first optical detector 122 in the optical interrogator 103. Similarly, the second return isolator 127 prevents unwanted reflections between the optical sensor assembly 102 and the second optical detector 123.

The first optical detector 122 provides a first detection signal having a magnitude that varies with the intensity of the first interferometric combination 132. Similarly, the second optical detector 123 provides a second detection signal having a magnitude that varies with the intensity of the second interferometric combination 133. The two aforementioned detection signals thus convey information about the physical quantity to be measured. Specifically, variations in the physical quantity produce variations in the magnitude of the first detection signal and of the second detection signal. These variations may be due to, for example, acoustic emissions that the sensing arm 105 of the optical sensor assembly 102 picks up.

The measurement processor 124 produces output data concerning the physical quantity on the basis of the two detection signals from the aforementioned optical detectors. To that end, the measurement processor 124 may, in effect, apply a combination of various known relationships, which are as follows. There is a known relationship between, on the one hand, the intensity of the first interferometric combination 132 and that of the second interferometric combination 133 and, on the other hand, the phase difference between the sensing return light 130 and the reference return light 131. There is a further known relationship between this phase difference and a difference between the optical path length of the sensing arm 105 and that of the reference arm 106. There is a yet further known relationship between the difference in the aforementioned optical path lengths and the physical quantity. Any of these know relationships may be determined empirically or through calculation, or a combination of these.

The output data that the measurement processor 124 produces can take many forms. For example, the output data may comprise a signal representing an acoustic emission. As another example, the output data may comprise parameters characterizing an acoustic emission. These parameters may concern, for example, at least one of the following: magnitude, frequency, and duration. These examples relate to use of the exemplary optical measurement systems 100-600 for acoustic emission testing. For other uses, the output data may comprise other elements. For example, the output data may comprise a value corresponding to that of the physical quantity to be measured, such as, for example, temperature, pressure, or strain.

The exemplary optical measurement systems 100-600 illustrated in FIGS. 1-6, as well as variants thereof, are particularly suited for carrying out sensitive and precise measurements in an environment that is harsh or hazardous, or both. First of all, the sensing fiber 113 may withstand the environment that is harsh and may be safe in the environment that is hazardous. The optical interrogator 103, which is generally not rated for these conditions, may be at a relatively large distance from this environment, at a safe location. This distance may be, for example, in the order of a few hundreds of meters, or a few kilometers, or even larger.

Rayleigh scattering and external disturbances are prevented from significantly affecting measurement precision in this configuration. Rayleigh scattering in the sensing arm 105 and in the reference arm 106 adversely affects measurement sensitivity and precision to a significantly greater extent than Rayleigh scattering in the optical forward path and in the optical return path. The same applies to external disturbances. The sensing arm 105 and the reference arm 106, which are sensitive to Rayleigh scattering and external disturbances, are relatively short. The optical forward path and the optical return path, which are relatively insensitive to Rayleigh scattering and external disturbances, are significantly longer than the aforementioned arms 105, 106. The optical forward path and the optical return path substantially cover the distance that separates the optical interrogator 103 from the environment 101 where measurements need to be made.

The exemplary optical measurement systems 100-600 illustrated in FIGS. 1-6 thus basically operate as described hereinbefore. However, the exemplary optical measurement systems 100-600 differ from each other in certain details. That is, each of the exemplary optical measurement systems 100-600 has certain specific features. These are discussed in what follows.

FIG. 1 illustrates a first exemplary optical measurement system 100 that comprises the following specific features. The coupling unit 117 integrally houses the reference arm 106. That is, the reference arm 106 is integrally comprised within the coupling unit 117. This makes that the reference arm 106 is isolated from the environment 101 where the physical quantity is to be measured. Consequently, the Faraday rotating mirror 116 that forms the reflective end 112 of the reference arm 106 is housed in the coupling unit 117. This Faraday rotating mirror 116 is thus protected from the environment 101 where the physical quantity is to be measured. The Faraday rotating mirror 115 that forms the reflective end 110 of the sensing arm 105 is also housed in the coupling unit 117 for the same reason. For the rest, the sensing arm 105 lies outside the coupling unit 117 traversing the environment 101 where the physical quantity is to be measured.

The sensing fiber 113, which forms part of the sensing arm 105, comprises a section that is wound on a sensing transducer 134. The sensing transducer 134 has a cross-sectional size that varies with the physical quantity to be measured. Consequently, the section of the sensing fiber 113 that is wound on the sensing transducer 134 may vary in length with the physical quantity. The sensing transducer 134 may make this variation in length to be relatively large for a given variation of the physical quantity. This, in turn, may make the optical path length of the sensing arm 105 to vary with the physical quantity to a relatively large extent. Accordingly, a relatively high measurement sensitivity may be obtained.

The sensing transducer 134 may comprise a solid material such as, for example, metal, plastic, or ceramic, or a combination of these. The sensing transducer 134 may have dimensions that are compliant with a range of frequencies of variations of the physical quantity to be measured. These variations may be due to sound waves from acoustic emissions. The cross-sectional size of the sensing transducer 134 may thus vary with the sound waves that the sensing transducer 134 receives. The sensing transducer 134 may be a resonant structure so that the cross-sectional size varies relatively strongly with the sound waves. An efficient coupling and pickup of the physical quantity may be obtained by the sensing transducer 134 having an appropriate geometry and appropriate material properties. For example, acoustic impedance matching may be achieved in this manner.

The reference fiber 114, which forms part of the reference arm 106, comprises a section that is wound on a reference support 135. The reference support 135 has a cross-sectional size that varies with the physical quantity to be measured to a significantly lesser extent than the cross-sectional size of the sensing transducer 134. In an extreme case, the cross-sectional size of the reference support 135 may even be independent of the physical quantity to be measured. Accordingly, the optical path length of the reference arm 106 may be independent of the physical quantity. Stated otherwise, in contrast with the sensing arm 105, the optical path length of the reference arm 106 may be insensitive to the physical quantity.

The reference support 135 may comprise a solid material with a high damping factor such as, for example, rubber or cork, or a combination of these. The reference support 135 will then be insensitive to sound waves, whereas, in contrast, the sensing transducer 134 is sensitive to sound waves.

The forward isolator 125 in the optical forward path is comprised in the optical interrogator 103. Similarly, the first return isolator 126 in the first branch of the optical return path is comprised in the optical interrogator 103. The same applies to the second return isolator 127 in the second branch of the optical return path, which is also comprised in the optical interrogator 103.

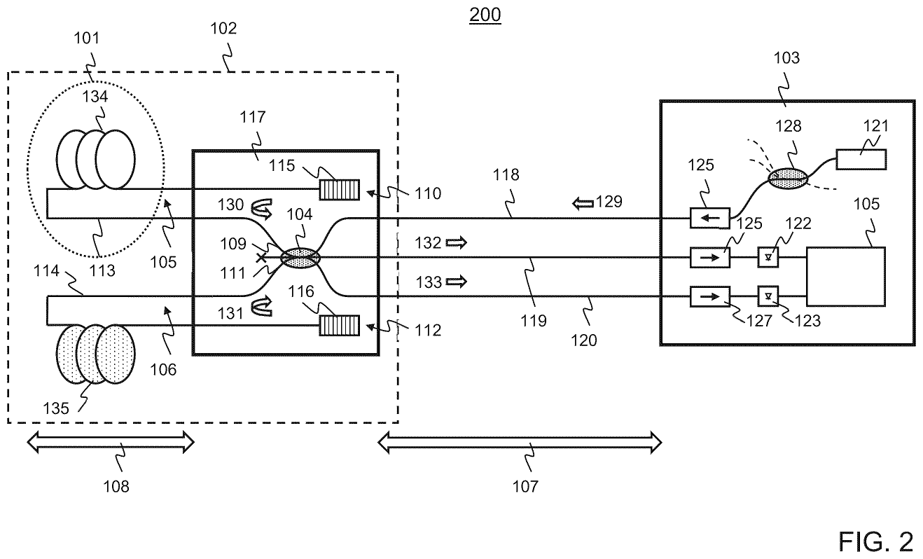

FIG. 2 illustrates a second exemplary optical measurement system 200, which differs from the first exemplary optical measurement system 100 in the following respects. In the second exemplary optical measurement system 200, the reference arm 106 is only partially comprised in the coupling unit 117. Specifically, a relatively large portion of the reference fiber 114 lies outside the coupling unit 117. The section that is wound on the reference support 135, as well as the reference support 135 itself, lie outside the coupling unit 117. However, the coupling unit 117 houses the Faraday rotating mirror 116 that forms the reflective end 112 of the reference arm 106. As mentioned hereinbefore, this Faraday rotating mirror 116 is thus protected from the environment 101 where the physical quantities is to be measured.

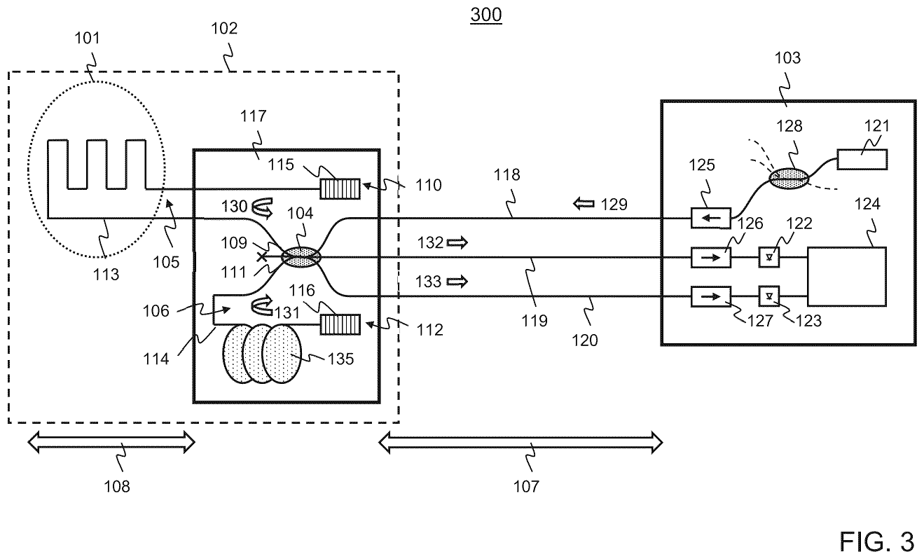

FIG. 3 illustrates a third exemplary optical measurement system 300, which differs from the first exemplary optical measurement system 100 in the following respects. Instead of being wound on a sensing support 134, a section of the reference fiber 114 is distributed otherwise over a support or in a support, which may jointly form a distributed transducer. For example, the section of the reference fiber 114 may be embedded in a composite material. As another example, the section of the reference fiber 114 may be glued to a surface of a suitable material, or fixed otherwise to the surface. In general, the section of the reference fiber 114 is part of a structure making this section to vary in length with the physical quantity to a relatively large extent. The structure may function as a microphone to pick up acoustic emissions. Moreover, the structure may protect the reference fiber 114 against damage.

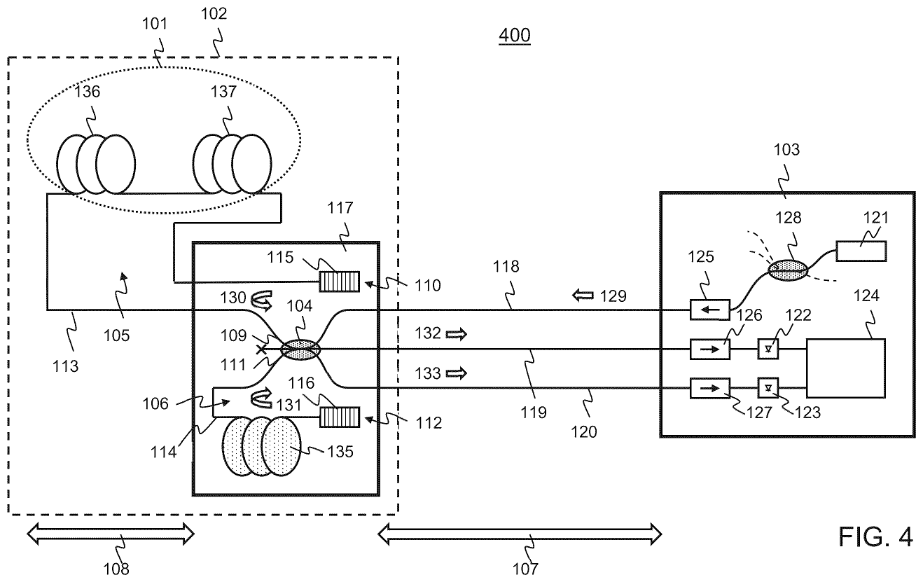

FIG. 4 illustrates a fourth exemplary optical measurement system 400, which differs from the first exemplary optical measurement system 100 in the following respects. The sensing arm 105 comprises a plurality of optical sensing sections at different locations. In this embodiment, the sensing arm 105 comprises two optical sensing sections 136, 137. For example, each of these may comprise a section of the sensing fiber 113 that is wound on a sensing transducer as discussed hereinbefore. This allows measuring two physical quantities at two different locations. The two physical quantities to be measured may be of the same nature, or of a different nature.

The first interferometric combination 132 may comprise two components, one brought about by one of the two optical sensing sections 136, the other component brought about by the other optical sensing section 137. The same applies to the second interferometric combination 133. These two components may be due to there being at least one optical characteristic in which the two optical sensing sections 136, 137 differ from each other. The optical interrogator 103 can be configured to distinguish between the two components.

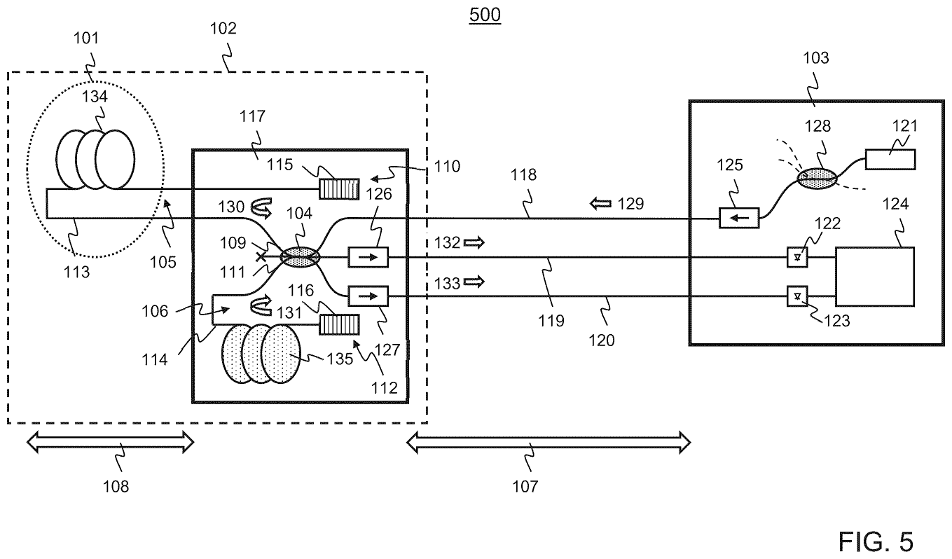

FIG. 5 illustrates a fifth exemplary optical measurement system 500, which differs from the first exemplary optical measurement system 100 in the following respects. Instead of being housed in the optical interrogator 103, the first return isolator 126 and the second return isolator 127 are housed in the coupling unit 117. This may prevent a significant amount of backscattered response light from entering the optical coupler 104 and reaching the sensing arm 105 or the reference arm 106, or both. A significant amount of backscattered response light may be generated in the optical return path if the distance 107 is relatively long, such as, for example, in the order of kilometers or even longer.

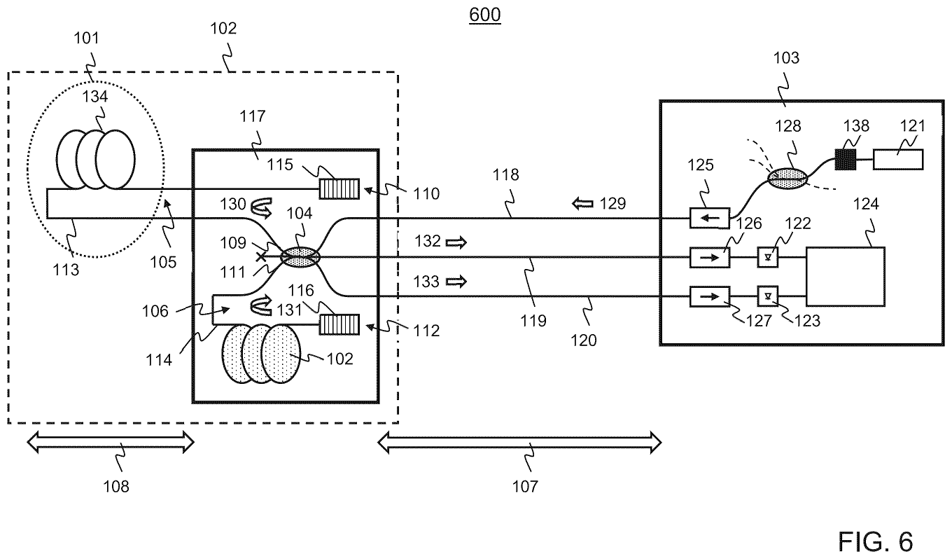

FIG. 6 illustrates a sixth exemplary optical measurement system 600, which differs from the first exemplary optical measurement system 100 in the following respects. The optical interrogator 103 includes an optical modulator 138 coupled between the light source 121 and the optical splitter 128. The optical modulator 138 may comprise, for example, an optical polarization modulator, or a phase modulator. A polarization modulator may switch the stimulus light 129 between at least three polarization states. This polarization switching is done at a rate that is at least three times higher than a rate at which the physical quantity to be measured is sampled. The stimulus light 129 thus has at least three polarization states that occur in an interlaced manner following one another at a relatively high rate. The optical interrogator 103 may then deinterlace the response light inversely. This polarization modulation technique may ensure that a component of the response light has a relatively high intensity for at least one polarization state. This, in turn, contributes to measurement precision and reliability.

An optical phase modulator may modulate the stimulus light 129 in phase or in optical frequency with a modulation signal of relatively high frequency. The modulation signal may be, for example, a sinewave, or band-limited noise. The relatively high frequency of the modulation signal may exceed a rate at which the physical quantity to be measured is sampled by at least an order of magnitude. This allows shifting noise that might be induced by Rayleigh backscattered light to a frequency band that lies outside a detectable range of the optical detectors 122, 123. This noise is then prevented from degrading measurement precision, in particular when the distance 107 is in the order of kilometers, or even longer.

The embodiments described hereinbefore with reference to the drawings are presented by way of illustration. The invention may be implemented in numerous different ways. In order to illustrate this, some alternatives are briefly indicated.

The invention may be applied in numerous types of products or methods related to optical measurements. As mentioned hereinbefore, the invention may be applied for optical measurement of acoustic emissions. This may be done for structural health monitoring or non-destructive testing, or both. Another contemplated application concerns partial discharge detection. Yet further contemplated applications include optical measurement of temperature, pressure, strain, and other types of physical quantities. In all these applications too, the invention allows relatively sensitive and precise measurements in an environment that is harsh, or hazardous, or both.

There are numerous different ways of implementing an optical measurement system in accordance with the invention. For example, in the embodiments presented hereinbefore, a Faraday rotating mirror is used to from the reflective end of the sensing arm and that of the reference arm. In other embodiments, another light reflecting structure or elements may be used, such as, for example, a plain mirror or a fiber Bragg grating. Such another embodiment may comprise a so-called polarization diversity receiver to prevent polarization fading from affecting measurement sensitivity and precision. Other techniques for mitigating polarization fading may be used.

As a further illustration that there many alternatives, embodiments different from those presented hereinbefore may comprise further optical isolators. For example, referring to the fifth exemplary optical measurement system 500 illustrated in FIG. 5, in a variant thereof, the optical forward path may comprise an additional optical isolator having a forward directionality like the forward isolator 125. This additional forward isolator may be present in the coupling unit 117. The variant of the fifth exemplary optical measurement system 500 may also comprise two further additional optical isolators in the optical return path. These two further additional optical isolators, which have a return directionality like the first return isolator 126 and second return isolator 127, may be present in the optical interrogator 103. One of these two additional return isolators may be arranged between the first return fiber 119 and the first optical detector 122. The other of the two additional return isolators may be arranged between the second return fiber 120 and the second optical detector 123.

The remarks made hereinbefore demonstrate that the embodiments described with reference to the drawings illustrate the invention, rather than limit the invention. The invention can be implemented in numerous alternative ways that are within the scope of the appended claims. All changes that come within the meaning and range of equivalency of the claims are to be embraced within their scope. Any reference sign in a claim should not be construed as limiting the claim. The verb “comprise” in a claim does not exclude the presence of other elements or other steps than those listed in the claim. The same applies to similar verbs such as “include” and “contain”. The mention of an element in singular in a claim pertaining to a product, does not exclude that the product may comprise a plurality of such elements. Likewise, the mention of a step in singular in a claim pertaining to a method does not exclude that the method may comprise a plurality of such steps. The mere fact that respective dependent claims define respective additional features, does not exclude combinations of additional features other than those reflected in the claims.

1. An optical measurement system comprising:
an optical sensor assembly adapted to receive stimulus light and to provide, in response, response light conveying information on a physical quantity to be measured; and
an optical interrogator adapted to provide the stimulus light and to extract the information on the physical quantity from the response light;
wherein the optical sensor assembly comprises:
a pair of reflective optical arms each adapted to receive input light at a coupling end and to provide, in response, return light at the coupling end according to a return response, wherein the return response of one reflective optical arm of the pair and the return response of the other reflective optical arm of the pair vary differently with the physical quantity to be measured;
an optical coupler that is optically coupled with the optical interrogator, the optical coupler being adapted to apply a portion of the stimulus light to the coupling end of the one reflective optical arm of the pair, and another portion of the stimulus light to the coupling end of the other reflective optical arm of the pair, and to provide the response light as several interferometric combinations of the return light from the one reflective optical arm of the pair and the return light from the other reflective optical arm of the pair, the several interferometric combinations differing from each other in that predefined different phase offsets are applied to a phase difference between the return light from the one reflective optical arm of the pair and the return light from the other reflective optical arm of the pair when these are interferometrically combined, the several interferometric combinations forming several components of the response light,
the optical measurement system further comprising:
a group of optical fibers that optically couples the optical coupler with the optical interrogator, the group of optical fibers comprising an optical fiber for transferring the stimulus light from the optical interrogator to the optical coupler and two further optical fibers, one for transferring one of the several interferometric combinations from the optical coupler to the optical interrogator, the other further optical fiber for transferring another one of the several interferometric combinations from the optical coupler to the optical interrogator,
wherein the optical coupler is located at a distance from the optical interrogator that is at least an order of magnitude larger than a distance range from the optical coupler within which the pair of reflective optical arms is deployed.

2. An optical measurement system according to claim 1, wherein the optical coupler is located at least 100 m from the optical interrogator.

3. An optical measurement system according to claim 1, comprising a coupling unit that houses the optical coupler and a reflective end of at least one of the reflective optical arms of the pair.

4. An optical measurement system according to claim 3, wherein the coupling unit houses the reflective end of the one reflective optical arm of the pair and the reflective end of the other reflective optical arm of the pair.

5. An optical measurement system according to claim 3, wherein the reflective end of at least one of the reflective optical arms of the pair comprises a Faraday rotating mirror.

6. An optical measurement system according claim 3, wherein the coupling unit further integrally houses one of the reflective optical arms of the pair, the other reflective optical arm of the pair traversing an environment where the physical quantity is to be measured.

7. An optical measurement system according to claim 1, wherein the one reflective optical arm of the pair has an optical path length that matches that of the other reflective optical arm of the pair.

8. An optical measurement system according to claim 1, wherein at least one of the reflective optical arms of the pair comprises a plurality of optical sensing sections at different locations.

9. An optical measurement system according to claim 1, wherein the reflective optical arms each comprise an optical fiber.

10. An optical measurement system according to claim 9, wherein the optical fiber of one of the reflective optical arms of the pair comprises a section that is coupled to a sensing transducer adapted to cause a variation in an optical characteristic within the section in response to a variation in the physical quantity.

11. An optical measurement system according to claim 10, wherein the optical fiber of the other reflective optical arm of the pair comprises a section that is coupled to an unresponsive medium adapted to prevent a variation in the optical characteristic within the section in response to a variation in the physical quantity.

12. An optical measurement system according to claim 1, comprising at least one optical isolator in an optical forward path through which the stimulus light passes.

13. An optical measurement system according to claim 1, comprising at least one optical isolator in an optical return path through which the response light passes.

14. (canceled)

15. An optical measurement system according to claim 1, wherein the optical interrogator comprises an optical modulator adapted to modulate the stimulus light.

16. An optical measurement system according to claim 15, wherein the optical modulator is adapted to switch the stimulus light between at least three polarization states at a rate at least three times higher than a rate at which the physical quantity to be measured is sampled.

17. An optical measurement system according to claim 15, wherein the optical modulator is adapted to modulate the stimulus light in phase with a modulation signal having a frequency that exceeds by at least an order of magnitude a rate at which the physical quantity to be measured is sampled.

18. An optical measurement system according to claim 1, wherein:
the optical sensor assembly forms part of a plurality of optical sensor assemblies;
the optical interrogator comprises an optical splitter adapted to provide stimulus light to the plurality of optical sensor assemblies; and
the optical interrogator is arranged to individually detect respective response lights from respective optical sensor assemblies among the plurality of optical sensor assemblies.

19. Use of optical measurement system according to claim 1 for measuring a physical quantity.
